(19) United States
(12) Patent Application Publication
(10) Pub. No.: US 2015/0253015 A1
(43) Pub. Date: Sep. 10, 2015

(54) METHOD OF TREATING SOILED INNER WALLS OF AN OVEN CAVITY AND OVEN IMPLEMENTED FOR EXECUTING SUCH A METHOD

(71) Applicants: Reiner Horstmann, Rothenburg ob der Tauber (DE); Christoph Luckhardt, Rothenburg ob der Tauber (DE); Arnd Hofmann, Rothenburg ob der Tauber (DE)

(72) Inventors: Reiner Horstmann, Rothenburg ob der Tauber (DE); Christoph Luckhardt, Rothenburg ob der Tauber (DE); Arnd Hofmann, Rothenburg ob der Tauber (DE)

(73) Assignee: Electrolux Home Products Corporation N.V., Brussels (BE)

(21) Appl. No.: 14/417,783

(22) PCT Filed: Aug. 28, 2012
(86) PCT No.: PCT/EP2012/066706

§ 371 Date: Jan. 27, 2015

(51) Int. Cl. F24C 14/00; B08B 9/087; B08B 9/093

(52) U.S. Cl. CPC F24C 14/005; B08B 9/093; B08B 9/087

(57) ABSTRACT

The invention in particular relates to a method of treating soiled inner walls of an oven cavity (3). The method comprises a step of mechanically nebulising a cleansing liquid (5) for generating a mist (11) of the cleansing liquid (5) within the oven cavity (3).

The present invention in particular is directed to a method of treating soiled inner walls of an oven cavity, in particular an oven cavity of a baking oven of household type, for example.

Cleaning the inner walls of cavities of ovens, in particular of domestic ovens, is frequently regarded by users as an annoying and disagreeable task. Sometimes it is quite laborious and troublesome to clean and remove deposits of foodstuff burnt in after a cooking or baking process, as in many cases the inner walls of the oven cavity, in particular the side and rear walls, are not that easy to access from the outside.

Therefore it is an object of the invention to provide a method that eases cleansing of the inner walls of a cavity of an oven, in particular of a baking oven. Further, a respective oven shall be provided.

According to claim 1, a method of treating soiled inner walls of an oven cavity in or during a cleansing process is provided. The oven in particular may be a baking oven, in particular a domestic baking oven. The oven cavity may also be referred to as an oven muffle.

The method comprises a step of mechanically nebulising with an automatic, self-contained cleansing unit a cleansing liquid, in particular into the oven cavity, for generating a mist of the cleansing liquid within or into the oven cavity. The term “generating a mist of the cleansing liquid within or into the oven cavity” in particular shall mean that the mist finally will be in, i.e. within, the oven cavity, in particular will penetrate or spread within the inner volume of the oven cavity.

Here it shall be noted, that the mist or fog may but does not necessarily has to be generated directly within the oven cavity. Mechanically generating the mist of cleansing liquid shall exclude generating mist by heating, i.e. applying heat energy to, the cleansing liquid.

By using the automatic and self-contained cleansing unit, the mist or fog of the cleansing liquid can be generated in a comparatively easy way. In particular, a mist or fog of the cleansing liquid can be generated until the inner walls of the baking chamber are evenly loaded with cleansing liquid sufficient to soak deposited dirt and soiling matter. Note that the terms “automatic” and “self-contained” in particular shall mean that the process of generating the mist or fog of cleansing liquid as such does not require user interaction or user actions. After activating the cleansing unit, the mist or fog may be generated automatically without any further user interaction.

Soil on inner walls of an oven cavity in general is generated by foodstuff and related substances, such as oil and the like, deposited on the cavity walls during use, i.e. baking, and, in particular burning-in during baking or cooking processes. Respective soiled inner cavity walls in many cases are difficult to clean.

The mist or fog of cleansing liquid mechanically generated, by a nebulising unit for example, spreads within the oven muffle or cavity, gets in contact with the soiled inner walls, in particular is deposited on the soiled inner walls, and soaks soiling matter or dirt adhering to the cavity walls. As a result, the inner walls of the oven cavity can be cleaned much easier as compared to soiled walls where soiling matter or dirt is not soaked with a cleansing liquid.

Note that it is preferred, that during operating the cleansing unit, i.e. during the generation of the mist of cleansing liquid, the oven cavity is closed and kept closed. In the closed state, the inner walls can be far better charged or loaded with the mist of cleansing liquid, and therefore deposited dirt and soiling matter can be soaked with cleansing liquid more efficiently.

A further advantage of the proposed method is that the mist of cleansing liquid can be generated comparatively energy-efficient, as compared for example with solutions in which a mist of cleansing liquid is generated by thermal vaporization.

In one embodiment of the method it is provided, that nebulising the cleansing liquid comprises applying at least one of a pressurized gas and ultrasonic wave energy to the cleansing liquid.

The pressurized gas may for example be generated by a, in particular small, compressor. Other devices for supplying gas, such as gas cylinders and the like, may be used.

For the generation of ultrasonic waves, ultrasonic atomizers, in particular piezoelectric wave generators, may be used.

The proposed mechanical variants for generating the mist or fog of cleansing liquid are comparatively easy and can be operated energy efficiently. Further, generating the mist or fog without the application of thermal energy, in particular without heating the cleansing liquid and inner space of the oven cavity, reduces the danger of burns and lesions on or at hot surfaces, in particular hot inner walls, of the oven cavity.

In other words, in executing the proposed method, the soiling matter and dirt may be soaked with cleansing liquid without further heating up the inner walls. The soiled matter and dirt can be mechanically removed by a user on comparatively cool inner walls.

According to a further embodiment, it is provided that nebulised cleansing liquid is distributed within the oven cavity by the action of a fan. Using a fan can enhance uniform distribution of the mist or fog of cleansing liquid within the oven cavity. As a consequence, dirt deposited in the inner cavity walls can be soaked uniformly in almost all sections of the inner wall of the oven cavity. Therefore, a subsequent mechanical cleaning, in particular a step of mechanically wiping off the inner walls of the cavity by a user, can be facilitated even for sections of the oven cavity that are difficult to access.

The fan used for distributing the nebulised cleansing liquid may be the fan of the oven intended and generally provided for recirculating air during cooking or baking processes. Therefore it may be of advantage, if a respective nebulising unit, at least an exit opening for the atomized or nebulised cleansing liquid, is mounted or placed close to the recirculating fan of the oven. It shall, however, be noted that the nebulising unit may comprise its own fan, in particular a fan separate from the recirculating fan, intended for recirculating air during baking or cooking.

In a further embodiment the proposed method comprises a further step of mechanically removing soil, in particular dirt or soiling matter, soaked with the cleansing liquid. Here, the oven cavity may, at least in some sections, comprise mechanical actuators adapted for mechanically removing the soaked dirt or soil. However, the step of removing the soaked soil may also involve user interaction, in particular as indicated further above.

According to claim 5, an oven, in particular a baking oven, preferably of household type, is provided. The proposed oven comprises an oven cavity and an automatic, self-contained cleansing unit. The cleansing unit is adapted to treat soiled inner walls of the oven cavity with a cleansing liquid. The treatment of the inner walls by the cleansing unit is conducted according to a method as proposed further above, in particular including any embodiments of the proposed method.

As to the terms “automatic” and “self-contained”, reference is made to the description above. In particular, it shall be noted that, once activated, the cleansing unit can generate the mist or fog of cleansing liquid without any further user interaction. The cleansing unit in particular can be implemented as a small apparatus adapted to generate a mist of cleansing liquid after activation, and to stop the generation of the mist of cleansing liquid after switching-off or deactivation.

The proposed oven has the advantage that cleaning of the inner walls can be conducted in a comparatively energy efficient and user friendly way. As to further advantages, further reference is in particular made to the description above.

In an embodiment of the oven, the cleansing unit comprises a compartment for accommodating the cleansing liquid. The compartment may be a component, in particular a fixed component of the oven, in particular of an inner wall of the oven, such for example a bottom or side wall of the oven cavity. In the alternative, the compartment may be a moveable compartment, adapted to be freely placed into and within the oven cavity. Such a separate compartment may be provided as an accessory part of the oven.

Here it shall be mentioned, that the cleansing liquid in the sense of the invention may be water, a detergent or a mixture thereof, i.e. a mixture of water and a detergent.

The compartment may be a comparatively small container, with a volumetric capacity far below that of the oven cavity. The volumetric capacity of the compartment may in particular be selected such that a volume of cleansing liquid for conducting a single cleansing process can be accommodated in the compartment. This means that all cleansing liquid contained in the compartment is nebulised in a single cleansing action. However, the volumetric capacity of the compartment may in the alternative be such that the cleansing liquid within the compartment is enough or sufficient for several cleansing operations.

Dimensioning the compartment such that only a single cleansing action can be performed, i.e. such that essentially no further cleansing liquid is contained in the compartment after finishing a cleansing action, has the advantage, that in a subsequent operation of the oven, in which the oven cavity is heated up, essentially no cleansing liquid is present and will be vaporized by the heat generated by heating elements of the oven.

For avoiding vaporization of the cleansing liquid due to heat generated by the heating elements of the baking oven during ordinary operation, which may be adequate both for non-hazardous and hazardous cleansing liquids, a lid, or something similar, for closing the container or an opening thereof may be provided. This in particular may be useful for compartments fixedly installed within the oven cavity.

In a further embodiment, the cleansing unit further comprises a nebulising unit implemented to mechanically nebulise the cleansing liquid by at least one of applying pressurized gas and ultrasonic waves to the cleansing liquid. Using the proposed type of nebulising unit has the advantage that a mist or fog of cleansing liquid can be generated in a comparatively energy efficient way, in particular as compared to generating a mist or fog of cleansing liquid by thermally vaporizing the cleansing liquid.

The nebulising unit using pressurized gas for generating the mist or fog of cleansing liquid may in particular comprise a compressor or any other type of pressure generator, such as for example but not restricted to pressure cylinders and gas containers.

For generating the mist or fog of cleansing liquid by ultrasonic waves, the nebulising unit may comprise an ultrasonic atomizer, preferably of piezoelectric type, in particular comprising a piezoelectric transducer or the like.

In yet further embodiments of the oven it is provided that the nebulising unit is adapted to be coupled to the compartment, or that the nebulising unit is implemented as an integrated part of the compartment, respectively, to directly nebulise the cleansing liquid by mechanical interaction.

Coupling of the nebulising unit to the compartment in particular may be such that essentially all energy generated by the nebulising unit is furnished or transferred to the cleansing liquid. Similarly, if the nebulising unit is implemented as an integrated part of the compartment and the nebulising unit can be directly coupled to the cleansing liquid, essentially all mechanical energy generated by the nebulising unit, in particular a piezoactuator, can be transferred to the cleansing liquid.

Transferring essentially all mechanical energy from the nebulising unit, in particular piezoactuator, to the cleansing liquid contributes to an energy efficient production of the mist or fog of cleansing liquid. In particular, for an optimal energy transfer from the nebulising unit to the cleansing liquid, the nebulising unit may be mechanically decoupled from all components not contributing to the generation of cleansing liquid mist or fog. In connection with avoiding or reducing the loss of excitation energy for generating the mist or fog of cleansing liquid, there may be provisions for decoupling the nebulising unit, in particular piezoactuator, from the walls of the oven cavity.

In one embodiment of the oven, it is provided that the cleansing unit, in particular the compartment, is an integrated part of, or fixedly coupled or installed to the oven cavity. In order to prevent a loss of excitation energy for nebulising the cleansing liquid, in particular in mechanical nebulising actions, the cleansing unit, in particular the compartment, may be mechanically decoupled from the cavity walls or load-bearing components o the oven cavity. At least it shall be prevented that the nebulising unit, in particular the piezoactuator, is in contact and excites the cavity walls, load-bearing components or sections thereof.

Implementing the cleansing unit as an integrated part has the advantage that it can be designed and configured in a comparatively user friendly and easy to operate way.

However, in a different embodiment it is provided that the cleansing unit is implemented independent from the oven cavity and freely placeable in and within the oven cavity. For example the independent cleansing unit may comprise a type of moveable and freely placeable, independent container for accommodating therein the cleansing liquid. Further there may be provided a piezoactuator coupled to the container such that cleansing liquid contained in the container can be efficiently, in particular energy efficiently, excited to generate the mist or fog of cleansing liquid inside the oven cavity.

In a yet further embodiment of the oven, it is provided that the cleansing unit is coupled to the oven via connection lines. In particular, the connection lines may be adapted for at least one of supplying electrical energy to the cleansing unit and for supplying or exchanging control commands.

In the case of supplying electrical energy, the cleansing unit may be coupled via connection lines with an energy source of the oven. In the case of supplying, in particular exchanging control commands with the cleansing unit, the cleansing unit or a controller thereof may be connected to a control unit of the oven. In particular it may be provided that the control unit of the oven functions as a controller or control unit for the cleansing unit. However, it shall be noted that the cleansing unit, in particular the nebulising unit, may be implemented as an independent, in particular stand-alone, unit that can be operated independently from the oven. Note that even in or for this case, the oven may comprise plug connectors adapted at least for supplying the cleansing unit, in particular nebulizer, with electric power.

In one embodiment, which has shortly been discussed further above, the nebulizer comprises an ultrasonic device, in particular an ultrasonic transducer, in particular of piezoelectric type, adapted to apply ultrasonic nebulising waves to the cleansing liquid. Ultrasonic devices, in particular transducers, preferably piezoactuators, are comparatively efficient and energy efficient with regard to generating a mist or fog of cleansing liquid.

The ultrasonic device may for example act on the container in which cleansing liquid is contained, or the ultrasonic device may be adapted to apply ultrasonic waves directly to the cleansing liquid. The ultrasonic device, in particular transducer, may for example be dipped into the cleansing liquid. Further it may be that the ultrasonic device protrudes into the volume of the compartment to be filled with cleansing liquid in ordinary operation.

In a further embodiment of the oven it is provided, as already indicated further above, that the nebulising unit is mechanically decoupled from the walls of the oven cavity. This is of particular advantage for optimizing the efficiency of mechanically generating the mist or fog of cleansing liquid. Decoupling in particular means that the loss of energy to neighboring or near components of the oven, such as walls of the oven cavity, can at least greatly be reduced, such that as much nebulising energy as possible can be transferred to the cleansing liquid.

In one further embodiment it is provided, that the oven further comprises a fan which is adapted and arranged such that in operation, nebulised or atomized cleansing liquid can be distributed essentially evenly within the oven cavity, i.e. distributed essentially evenly to or over the inner walls of the oven cavity. An even distribution of the mist or fog of cleansing liquid may be advantageous for soaking or dissolving dirt or soiling matter extensively, i.e. essentially over the whole area of the inner walls of the oven cavity. In particular in this way a subsequent mechanical cleaning step in which dirt and soil particles are removed from the cavity walls can greatly be enhanced and facilitated.

As to further advantages and advantageous effects of the oven, reference is made to the description above and further below.

In all it can be seen, that the proposed method and oven are suitable for easing cleaning of the inner walls of the oven cavity, in particular in an energy efficient way.

Embodiments of the invention will now be described in connection with the annexed figures, in which.

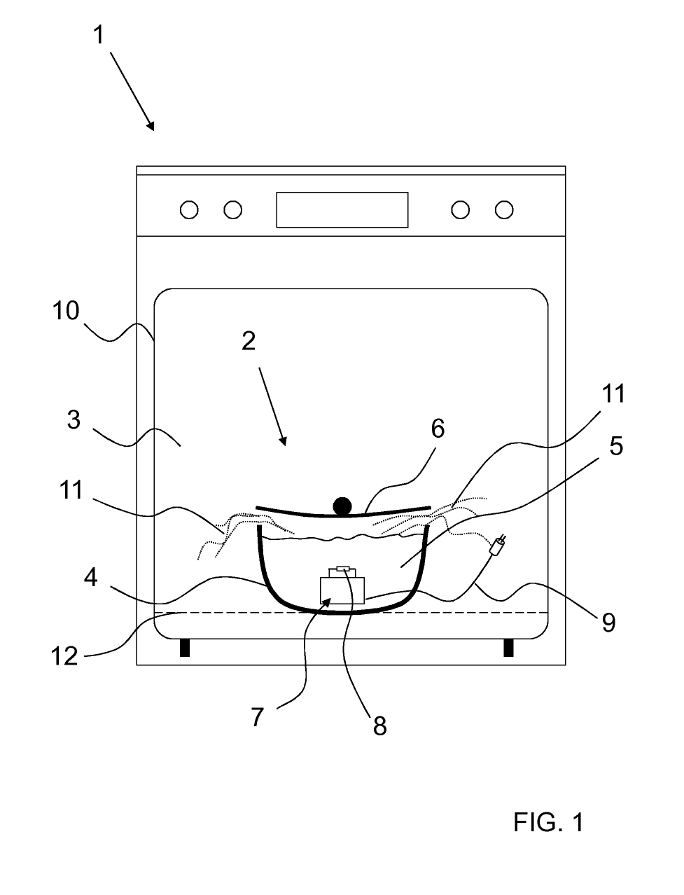

FIG. 1 shows a schematic representation of a baking oven comprising a stand-alone type cleansing unit;

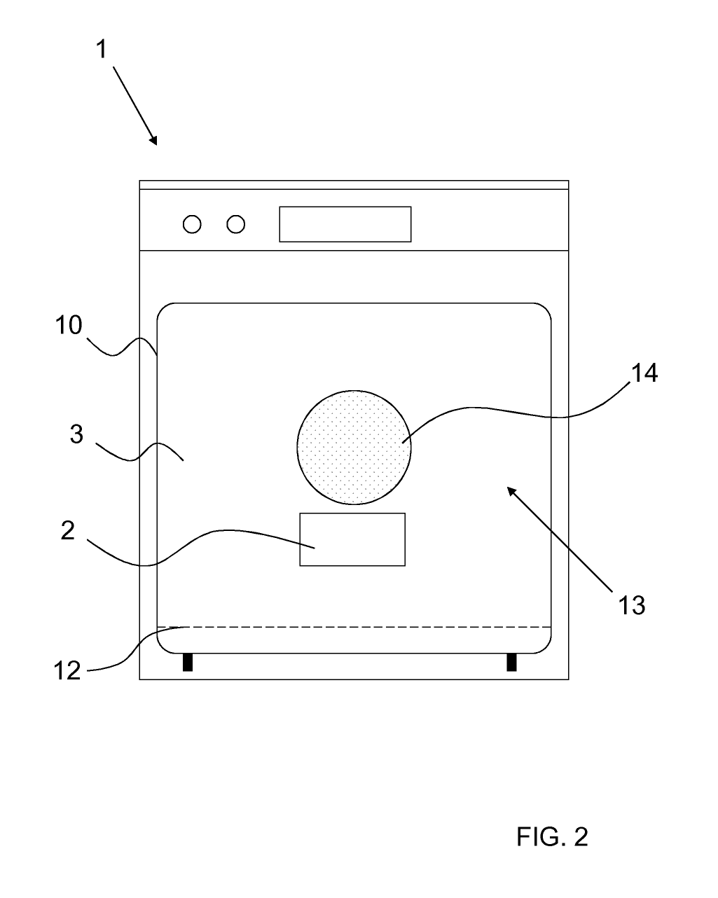

FIG. 2 shows a schematic representation of a baking oven with a cleansing unit integrated with the oven cavity; and

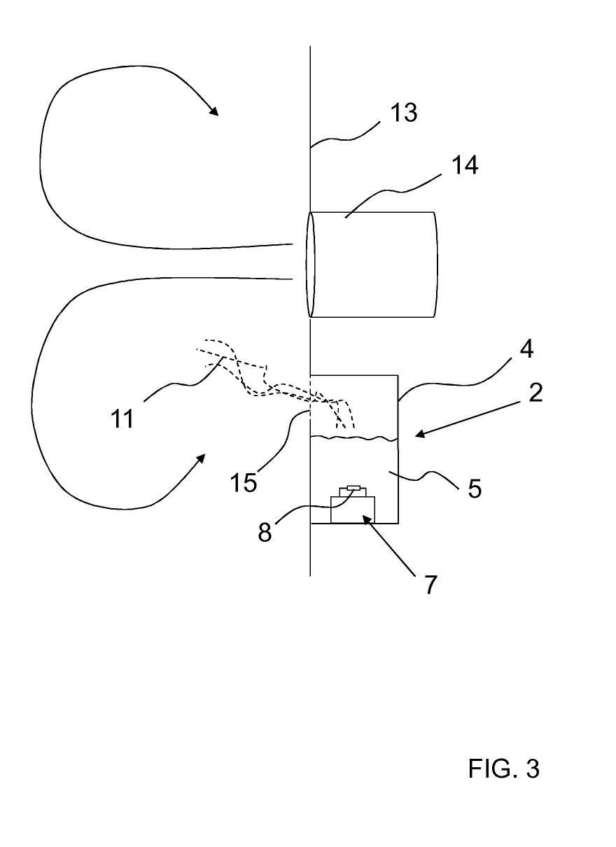

FIG. 3 shows an enlarged cross sectional view of the cleansing unit of FIG. 2.

Unless otherwise mentioned, like elements are designated by like reference signs throughout the figures.

FIG. 1 shows a schematic representation of a baking oven 1 comprising a stand-alone type automatic and self-contained cleansing unit 2. The baking oven 1 further comprises a baking chamber 3, i.e. an oven cavity.

The cleansing unit 2 comprises a compartment 4 adapted for at least accommodating a cleansing liquid 5. The cleansing unit 2 further comprises a lid 6 adapted for closing and releasing the compartment 4 with respect to the exhaustion of cleansing liquid 5.

The cleansing unit 2 further comprises a nebulising unit 7 which in the present case comprises an ultrasonic wave generator 8 or transducer, in particular of piezoelectric type. The nebulising unit 7 comprises a connection line 9 via which the nebulising unit 7 can be connected to a control unit (not shown) of the baking oven 1 as well as to a power supply (not shown) of the baking oven 1.

As can be seen in particular from FIG. 1, the cleansing unit 2 is implemented as a component essentially independent from the baking chamber 3 and baking oven 1. The cleansing unit 2 is adapted in such a way to the dimensions and design of the baking chamber 3 such that it can freely and essentially at any timepoint be placed within the baking chamber 3 and be connected to the control and power supply of the baking oven 1 for operating the cleansing unit 2, i.e. for conducting a cleansing operation.

Operation and usage of the cleansing unit 2 is as follows. In case that the inner walls of the baking chamber 3 are soiled, which generally occurs in operating the baking oven 1, for example by baking or cooking food, a user intends to clean the inner walls from dirt and soiling matter resulting for example from deposited and burnt-in foodstuff, oil and the like.

In this situation, the user places the cleansing unit 2 into the baking chamber 3 connects the connection line 9 to the baking oven 1 and operates the cleansing unit 2 with the door of the baking chamber 3 being closed.

Upon activating the cleansing unit 2, in particular the nebulising unit 7 and ultrasonic wave generator 8 are activated. Operation of the ultrasonic wave generator 8 results in generating a mist 11 or fog of the cleansing liquid 5 contained in the compartment and being in direct interaction with the nebulising unit 7. The mist 11 of the cleansing liquid 5 distributes and spreads over and within the baking chamber 3 and also reaches and is deposited on the dirty and soiled inner walls of the baking chamber 3.

As a result, the dirt and soiling matter deposited and adhering to the inner walls of the baking chamber 3 are soaked with the cleansing liquid 5, which may comprise water and optional a detergent.

Soaking the dirt and soiling matter with the cleansing liquid 2 considerably facilitates removing, in particular wiping away, the dirt and soiling matter by the user in a manual action. Therefore, it becomes clear that generating the mist 11 or fog of cleansing liquid 5 greatly improves and alleviates for a user the process of cleaning the inner walls of the baking oven 1.

In the present embodiment, the cleansing unit 2 is implemented essentially as a stand alone type apparatus, independent from the baking chamber 3. Such a variant in particular may be advantageous for retrofitting existing and established baking ovens. Further, the cleansing unit 2 may be freely placed within the baking chamber 3, in particular at different levels according to the baking levels in which a baking grid or baking tray 12 can be placed.

With the cleansing unit 2 as shown in FIG. 1, the nebulising unit 7, in particular ultrasonic wave generator 8, can be implemented to be mechanically decoupled from the baking chamber 3 and respective chamber walls. This has the advantage that essentially no leakage of ultrasonic waves occurs, which would impair the energy efficiency of the nebulising unit 7. Or in positive words, essentially all of the ultrasonic wave energy can be transferred to the cleansing liquid 5 within the compartment 4, resulting in a favorable energy efficiency and advantageous efficiency in mist generation.

Note that alternatively or in addition to operating an ultrasonic wave generator, a mist generator based on pressurized gas may be provided. Such a mist generator may be operated with pressurized gas or air, for example, generated by a compressor or provided by a gas or air container or cylinder.

FIG. 2 shows a schematic representation of a baking oven 1 with an automatic and self-contained cleansing unit 2 integrated with the oven cavity 3. The cleansing unit 2 in the present case is implemented as an integral part of a rear wall 13 of the baking oven 1, in particular baking chamber 3. It shall however be noted that the cleansing unit 2 may also be implemented at, in particular integrated with, a side or bottom wall of the baking chamber 2.

In the embodiment of FIG. 2, the cleansing unit 2 is arranged below a fan 14 of the baking oven 1. The fan 14 in general is used during ordinary operation of the baking oven 1 for circulating air, in particular hot air within the baking chamber 3.

FIG. 3 shows an enlarged cross sectional view of the cleansing unit 2 of FIG. 2. As can be seen from FIG. 3, the cleansing unit 2 is implemented as an integrated part of the rear wall 13 of the baking chamber. In a similar way, the cleansing unit 2 may be integrated in side and/or bottom wall of the baking chamber 3. It shall be noted that the baking oven 1 can comprise more than just one cleansing unit 2. Further, instead of implementing the cleansing unit 2 as an integrated part it may be mounted to a respective inner wall section of the baking chamber 3.

In the present embodiment, the cleansing unit 2, in particular the compartment 4, is arranged below the fan 14 of the baking oven 1. This has the advantage that mist 11 generated by the nebulising unit 7 and ultrasonic wave generator 8 can be evenly and essentially homogenously distributed within the baking chamber 3.

An even and essential homogenous distribution of the mist 11 of the cleansing liquid 5 within the baking chamber 3 has the advantage that essentially and nearly all locations can and will be reached by the cleansing liquid 5. Hence, dirt and soiling matter disposed and burnt in at almost any location within the baking chamber 3 can be soaked essentially equally with the cleansing liquid 2. As a consequence, essentially all locations of the baking chamber 3, in particular of the inner walls of the baking chamber 3, can be cleaned and removed from dirt and soiling matter in a comparatively easy way by the user in a manual action.

Note that the airflow, i.e. the air circulation, generated by the fan 14 is schematically indicated in FIG. 3 by respective circular arrows.

With the present embodiment, the cleansing unit 2 is implemented as an integrated part of the rear wall 13 of the baking chamber 3. In order to prevent, or at least limit or restrict loss of ultrasonic wave energy intended for nebulising the cleansing liquid 5 to the inner walls of the baking chamber 3, the nebulising unit 7, in particular the compartment 4, may be mechanically decoupled from the baking chamber 3, in particular the respective inner wall.

It shall be noted, that the nebulising unit 7 may be fixedly installed within the compartment 4, or the nebulising unit 7 may be implemented to be put into and/or coupled to the compartment on demand, i.e. when a user intends to operate the nebulising unit 7.

As to the function and operational results of the nebulising unit 7 shown in FIGS. 2 and 3, the description of the nebulising unit 7 of FIG. 1 essentially applies mutatis mutandis. Therefore, reference is made to the description above.

The nebulising unit 7 implemented as an ultrasonic wave generator 8 and shown in connection with the figures generates a mist 11 or fog of the cleansing liquid 5 by applying mechanical energy to the cleansing liquid 5. This has the advantage over generating a mist or fog of a cleansing liquid by thermal heating energy that less energy is needed for mist generation. Further, mechanically generating the mist 11 of cleansing liquid has the advantage, that the inner walls of the baking chamber 3 will not be heated up, which simplifies a subsequent mechanical cleaning process conducted by the user.

In the embodiments shown and described in connection with the figures, the ultrasonic wave generator 8 is positioned and mounted in such a way that it directly acts on the cleansing liquid 5 within the compartment 4. With the embodiments, the ultrasonic wave generator 8 is mounted and arranged within the compartment 4. In a variant (not shown), the ultrasonic wave generator 8 may for example be arranged outside of the compartment 4. A mist 11 of the cleansing liquid 5 in this case may be generated by indirect action of the ultrasonic wave generator on the cleansing liquid 5. For example, the ultrasonic wave generator may be coupled to a wall of the compartment 4 in such a way that the ultrasonic wave generator excites a respective segment of the compartment wall which transfers the ultrasonic wave energy to the cleansing liquid 5 to thereby nebulise the cleansing liquid 5 and generate the mist 11 of cleansing liquid 5.

The nebulising unit 7, in particular the ultrasonic wave generator 8 may be connected via a connection line to at least one of a control unit and power supply unit of the baking oven 1. This situation is similar to the embodiment in FIG. 1, and reference is made to the respective description which applies mutatis mutandis to the embodiment shown and described in connection with FIG. 2 and FIG. 3.

The nebulising unit 8 of the embodiment of FIG. 2 and FIG. 3 is more difficult to access than the nebulising unit 8 of FIG. 1. Therefore, it may be provided that the status, in particular the operational status of the cleansing unit 2 in particular nebulising unit 8, is indicated on a display unit of the baking oven 1. As an example, the filling level of the compartment 4 may be displayed on the display unit.

Further, a filling nozzle, a ducting or something similar may be provided for supplying or filling the cleansing liquid 5 into the compartment 4.

In the integrated embodiment shown and described in connection with FIG. 2 and FIG. 3, the rear wall 13 may comprise an aperture constituting and coinciding with an opening 15 of the compartment 4. The opening 15 in particular may be adapted to optimally distribute the cleansing liquid 5, in particular the mist 11 of cleansing liquid 5 within the baking chamber 3, in particular in connection with operating the fan 14 during the nebulising action.

The opening 15 may comprise a lid (not shown) adapted to connect or disconnect the compartment 4 to and with the inner volume of the baking chamber 3. Such a lid may be advantageous, as it can be closed during ordinary non-cleansing operation of the baking oven 1. As a consequence, evaporation of the cleansing liquid 5 during baking operations can be prevented, or at least be suppressed.

In all, it can be seen, that the proposed method and baking oven are effective in easing cleansing of the inner walls of the baking chamber 3 of the baking oven 1.

In addition, it has to be stated that the fog or mist generated by a piezoactuator or by compressed air has an advantage compared to steam created by boiling water. Due to the larger size of the droplets forming the fog or mist, compared to the steam molecules, more of the detergent can be transported to the cavity walls.

### LIST OF REFERENCE NUMERALS

1 baking oven
2 cleansing unit
3 baking chamber
4 compartment
5 cleansing liquid
6 lid
7 nebulising unit
8 ultrasonic wave generator
9 connection line
10 door
11 mist
12 baking tray
13 rear wall
14 fan
15 opening

1. Method of treating soiled inner walls of an oven cavity (3) in a cleansing process, comprising a step of mechanically nebulising with an automatic, self-contained cleansing unit (2) a cleansing liquid (5) for generating a mist (11) of the cleansing liquid (5) within the oven cavity (3).

2. Method according to claim 1, wherein nebulising the cleansing liquid (5) comprises applying at least one of a pressurized gas and ultrasonic wave energy to the cleansing liquid (5).

3. Method according to claim 1, wherein nebulised cleansing liquid (11) is distributed within the oven cavity (3) by the action of a fan (14)

4. Method according to claim 1, comprising the further step of mechanically removing soil soaked with the cleansing liquid (5).

5. Oven (1), comprising an oven cavity (3) and an automatic, self-contained cleansing unit (2) adapted to treat soiled inner walls of the oven cavity (3) with a cleansing liquid (5), according to a method of claim 1.

6. Oven (1) according to claim 5, wherein the cleansing unit (2) comprises a compartment (4) for accommodating the cleansing liquid (5).

7. Oven (1) according to claim 5, wherein the cleansing unit (2) further comprises a nebulising unit (7) implemented to mechanically nebulise the cleansing liquid (5) by at least one of applying pressurized gas and ultrasonic waves to the cleansing liquid (5).

8. Oven (1) according to claim 6, wherein the nebulising unit (7) is adapted to be coupled to the compartment (4).

9. Oven (1) according to claim 7, wherein the nebulising unit (7) is implemented as an integrated part of the compartment (4), respectively, to directly nebulise the cleansing liquid (5) by mechanical interaction.

10. Oven (1) according to claim 5, wherein the compartment (4), is an integrated part of the oven cavity (3).

11. Oven (1) according to claim 5, wherein the cleansing unit (2) is implemented independent from the oven cavity (3) and freely placeable within the oven cavity (3).

12. Oven (1) according to claim 5, wherein the cleansing unit (2) is coupled to the oven (1) via connection lines (9) for at least one of supplying the cleansing unit (2) with electrical energy and control commands.

13. Oven (1) according to claim 7, wherein the nebulising unit (7) comprises an ultrasonic device (8) adapted to apply ultrasonic nebulising waves to the cleansing liquid (5).

14. Oven (1) according to claim 13, wherein the nebulizing unit (7) is mechanically decoupled from the walls of the oven cavity (3).

15. Oven (1) according to claim 5, further comprising a fan (14) adapted and arranged in such a way that in operation, nebulised cleansing liquid (11) is distributed essentially evenly within the oven cavity (3)
